(19) United States
(12) Patent Application Publication
(10) Pub. No.: US 2012/0312394 A1
(43) Pub. Date: Dec. 13, 2012

(54) COMPENSATED PRESSURE REDUCTING DEVICE

(76) Inventors: Maurizio Grando, Cassola (VI) (IT); Stefano Spagnol, Cordenons (PN) (IT); Giuseppe Veronese, Montegrotto Terme (PD) (IT); Luca Sartorello, Monselice (PD) (IT)

(21) Appl. No.: 13/580,668

(22) PCT Filed: Feb. 15, 2011
(86) PCT No.: PCT/EP11/52183

§ 371 Date: Aug. 23, 2012

(30) Foreign Application Priority Data
Feb. 23, 2010 (IT) PD2010A000053

(51) Int. Cl. F16K 31/36

(52) U.S. Cl. 137/501

(57) ABSTRACT

There is described a device for reducing the delivery pressure of a combustible gas, particularly for systems supplying gas to internal combustion engines for automotive vehicles, comprising a valve seat (5) positioned in a gas flow tube (2) formed in the body (1a) of the reducer, between an inlet section (3) and an outlet section (4), a diaphragm-operated plug element (6) associated with said valve seat (5) and movable along a predetermined axial direction (X) for the purpose of opening and closing the seat (5), a spring device (9) acting on the to diaphragm to subject the latter to a predetermined resilient load, an actuator rod (11) connected for operation to the plug (6) and to the diaphragm, a pressure compensator element (12) which is fixed to the plug (6) upstream of the valve seat with respect to the direction of flow, and which is axially extensible along that direction as a result of the movement of said plug (6) relative to the valve seat (5). The compensator element (12) comprises a tubular body shaped in the form of a bellows, internally hollow and extending axially between opposite axial ends, one of which is connected to the plug (6) while the other is connected to a stationary structure of the reducer, the inner cavity (13) of the tubular body being sealed to separate it from the outside of the body, a predetermined pressure being created in the cavity (13).

### TECHNICAL FIELD

The present invention relates to a pressure reduction device of the compensation type, particularly for combustible gas systems for supplying internal combustion engines for automotive vehicles, having the features set out in the preamble of main claim 1.

### TECHNOLOGICAL BACKGROUND

Pressure reduction devices are widely used in the field of engines for automotive vehicles using combustible gas to supply the engine with a pressure which is reduced appropriately with respect to the pressure to which the gas is subjected in the storage cylinders of the system. Reductions which involve lowering the inlet pressure at the reducer, is generally between 15 and 260 bar, to an outlet pressure having values of approximately from 1 to 10 bar are typical for these applications. In reducers with diaphragm type control and resilient loading (adjustable or non-adjustable), when the reduction system is placed under pressure, the gas has its pressure reduced in the region of the plug and is introduced into the body of the reducer until the outlet pressure reaches the desired value acting counter to the resilient loading of the spring, thereby causing the diaphragm of the control unit to move in the closure direction of the plug. Therefore, the system tends to achieve a position of equilibrium between the loading of the spring and the outlet pressure. However, the outlet pressure varies in accordance with the flow rate and is influenced by the inlet pressure whilst it would be desirable for the outlet pressure to be kept constant. In order to overcome that disadvantage, there is provision in accordance with a known solution for the construction of sections of the valve seat that are greatly reduced, consequently increasing the movement paths of the plug. In that manner, the influence of the force owing to the inlet pressure on the plug tends to become negligible. With great travel paths which are necessary to open the seat in order to ensure the flow rate required, however, the resilient force of the spring (proportional to that path) tends to be substantial relative to the total adjustment force. Vice versa, with travel paths of the plug that are greatly reduced, the influence of the position of the plug would become negligible (with a resilient force of the spring that is practically constant), but in that case making very large sections of the seat necessary, the influence of the force produced by the inlet pressure acting on the sealing seat would be greatly dependent on the inlet pressure, thereby leaving the above-mentioned problems unresolved. In other fields, where there are required great reductions in pressure when gas is being used, it is known to use pressure compensator devices which allow the influence of the pressure variation at the inlet of the reducer to be made substantially negligible. Those compensators can be constructed in the form of extensible bellows which are secured to the plug of the sealing seat and on which the inlet pressure acts externally. Owing to the geometry of the bellows, the action of the inlet pressure on the plug makes the forces owing to that pressure on the plug itself negligible, overcoming the mechanism by the great variation in the force owing to the inlet pressure, and consequently allowing the use of seats having large sections. However, such applications are not known in the field of internal combustion engines for motor vehicles which use combustible gas.

### DESCRIPTION OF THE INVENTION

An object of the invention is to improve the use of pressure compensator devices in pressure reducers for gas combustion engines for motor vehicles, in particular in single-stage reducers with high reduction ratios and a great variation in the inlet pressure at the reducer, these being typical conditions which may be encountered in this specific technical field. This object is achieved by the invention by means of a pressure reduction device constructed in accordance with the appended claims.

### BRIEF DESCRIPTION OF THE DRAWINGS

Other features and advantages of the invention will be better appreciated from the following detailed description of a preferred embodiment thereof which is illustrated merely by way of non-limiting example with reference to the appended drawings, in which:

FIG. 1 is a schematic axial section of a pressure reducer constructed in accordance with the present invention,

FIG. 2 is a perspective view, drawn to an enlarged scale, of a detail of the pressure reducer of FIG. 1,

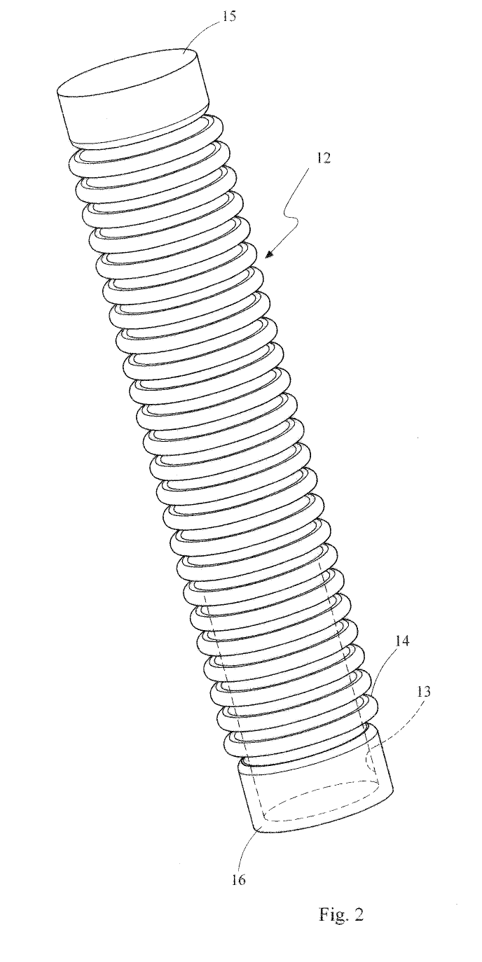

FIG. 3 is a general perspective view in relation to a pressure reducer constructed in accordance with the invention.

### PREFERRED EMBODIMENT OF THE INVENTION

With reference to the Figures mentioned, a pressure reducer is generally designated 1 and is intended for a combustible gas system for supplying an internal combustion engine for motor vehicles constructed in accordance with the invention.

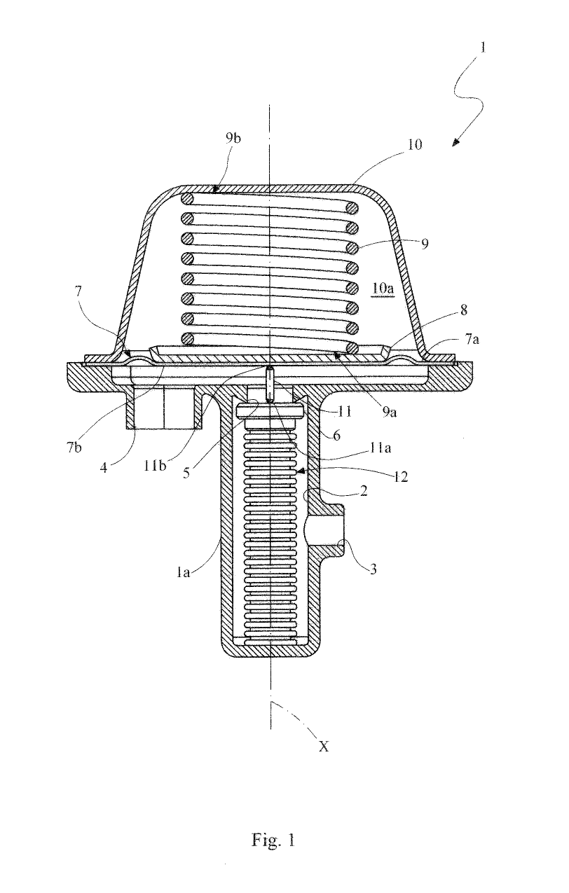

There is formed in the body is of the reducer 1 a gas flow tube 2 which extends between an inlet section 3 and an outlet section 4. Between those sections, there is provided in the tube a valve seat 5, with which there is associated a plug 6 which can be moved during the opening/closing movement of the seat along a predefined axial direction designated X in FIG. 1.

A control unit which has a diaphragm 7 and which is provided downstream of the seat 5 with respect to the direction of flow is connected to the plug 6. A plate 8, against which one 9a of the axial ends of a spring device 9 acts, adjoins a side of the diaphragm that is designated 7a. The opposite axial end 9b of the spring device abuts a wall 10 of a chamber 10a for receiving the spring device itself. The diaphragm side 7a is subjected to a reference pressure present in the chamber 10a, typically the pressure of the inlet manifold of the engine. The opposite diaphragm side designated 7b is is subjected to the outlet pressure present downstream of the plug in the region of the outlet section 4.

The diaphragm 7 is positioned in a plane perpendicular to the axial direction X. The diaphragm 7 is further connected operationally to the plug 6 by means of an actuator rod 11 which extends axially in the direction X and is centrally secured to the plug 6 at an end 11a thereof, the other opposite end 11b being capable of contact with the diaphragm 7 during the control movement thereof in the direction X away from and towards the valve seat. The reduction device 1 comprises a pressure compensation element which is generally designated 12 and which is in the form of a bellows which is axially extensible in the direction X and which is operationally associated with the plug 6. In greater detail, the compensator 12 is formed by means of a tubular body with a cylindrical extent and an inner cavity 13 which is delimited by a flexible side wall which has a plurality of corrugations 14 with preferential bending lines which can allow the bellows type movement, that is to say, the axial shortening or lengthening of the tubular wall. At the opposing axial ends of the tubular body, there are provided ends 15, 16 for closing the tubular body, of which one 15 is itself secured to the plug (at the opposite side to the one involved with the rod 11), the other 16 being secured to a stationary structure of the reducer. The inner cavity of the tubular body is closed by means of the closure ends 15, 16 with tight sealing towards the outer side of the body itself. With the sealing of the cavity, there can further be preselected a pressure to which the tubular cavity is intended to be subjected. That pressure may be advantageously selected so as to be equal to atmospheric pressure, but other pressure values may equally well be predefined in accordance with specific requirements.

Advantageously, the bellows type compensator 12 is constructed from metal material.

Owing to the active compensator 12 being provided on the plug 6, the pressure at the inlet section of the reducer is substantially compensated for, making the pressure forces applied thereby to the plug substantially negligible. The inlet pressure, owing to the effect of the geometry of the compensator, acts on the side walls of the bellows, affected by the corrugations 14, thereby balancing the resultants of the forces applied, in particular in the direction X. Therefore, that compensation frees the system from the great variation of force owing to the inlet pressure, thereby allowing the use of sections of a valve 5 which have a substantial extent and which become extremely advantageous owing to the stability of the outlet pressure in accordance with the flow rate. Owing to the provision of a bellows which is sealed and air-tight with respect to the exterior, the reference pressure inside the bellows can be kept constant, with equilibrium of the system which determines the outlet pressure from the reducer. That reference pressure may be atmospheric pressure, as indicated above, but any other reference pressure could be preselected.

The possibility of providing sections of the valve seat with a great extent further allows a substantial reduction in the operational travel paths of the plug away from and towards the valve seat in order to determine the flow rate of gas required. Such a reduction in the travel path is reflected in equal measure in the axial extension to which the bellows is subjected. Reduced extensions of the bellows advantageously allow the diaphragm to be constructed from a metal material, as an alternative to rubber materials which are typically used and necessary in the presence of great axial extensions. Diaphragms composed of metal materials allow longer service-lives to be obtained owing to reduced damage from a chemical point of view with respect to the rubber materials normally used.

Owing to the pressure compensation effect obtained with the bellows, the plug which is urged by forces owing to the reduced pressure, can advantageously be composed of rubber, rather than plastics materials, such as those normally used in applications without any compensation means, where there are great loads owing to the pressure forces, with resultant greater occurrences of wear and problems relating to the sealing of the valve seat.

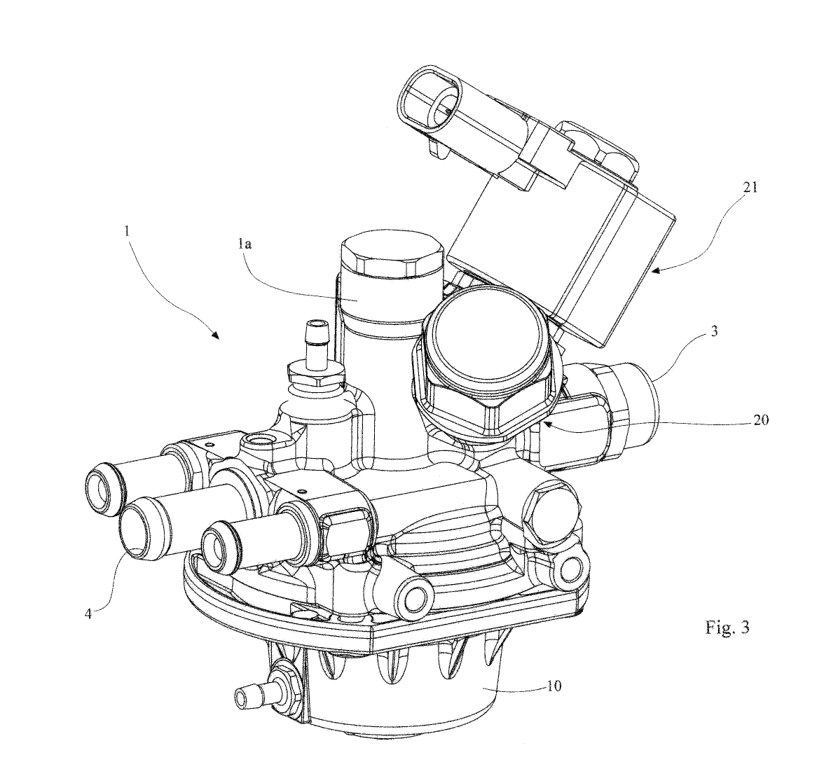

With explicit reference to FIG. 3, relating to a general view of the whole of the reducer according to the invention, it will be appreciated how the provision of a compensation bellows of the type claimed allows the construction of a substantially single-stage reducer unlike the twin-stage reducers of known solutions, bringing about an obvious reduction in the overall spatial requirement. Owing to that prerogative, it is advantageously possible to provide both the pressure sensor and the solenoid valve for the gas which are designated 20 and 21 in FIG. 3, respectively, in a position near the bellows in the region of the inlet section 3 of the gas, thereby retaining a reduced overall spatial requirement for the entire reducer (even when provided with the above-mentioned components) unlike the known solutions, in which the above-mentioned components necessarily involve an increase in the spatial requirement with respect to the spatial requirement owing to the twin-stage of reduction.

During operation, when the reducer is in a rest state, the spring device 9 acts, by means of the resilient preloading applied thereto, on the plate 8 and on the diaphragm 7 which move the plug 6 in an opening manner via the rod 11. When the system is pressurised and begins to operate, the pressure of the gas is reduced in the region of the plug 6 and the gas is introduced into the region downstream of the valve seat 5 until the outlet pressure reaches the desired value, unloading the spring device 9 and thereby causing the diaphragm 7 and the plate 8 to move in opposite directions, moving the plug 6 into a closure position. The system continues to operate continuously, seeking equilibrium between the load of the spring device and the outlet pressure.

The invention thereby achieves the objects set out, resulting in the above-mentioned advantages over known solutions.

1. A device for reducing the delivery pressure of a combustible gas, particularly for systems supplying gas to internal combustion engines for automotive vehicles, comprising:
a valve seat positioned in a gas flow tube formed in the body of the reducer, between an inlet section and an outlet section,
a diaphragm-operated plug element associated with said valve seat and movable along a predetermined axial direction for the purpose of opening and closing the seat,
a spring device acting on the diaphragm to subject the latter to a predetermined resilient load,
an actuator rod connected for operation to the plug and to the diaphragm,
a pressure compensator element which is fixed to said plug upstream of the valve seat with respect to the direction of flow, and which is axially extensible along said direction as a result of the movement of said plug relative to the valve seat, wherein said compensator element comprises a tubular body shaped in the form of a bellows, internally hollow and extending axially between opposite axial ends, one of which is connected to the plug while the other is connected to a stationary structure of the reducer, and in that the inner cavity of the tubular body is sealed to separate it from the outside of said body, a predetermined pressure being created in the cavity.

2. The device according to claim 1, wherein the predetermined pressure in the tubular cavity of the bellows-shaped compensator is equal to atmospheric pressure.

3. The device according to claim 1, wherein the axially extensible tubular body of the bellows-shaped compensator is made from metal material.

4. The device according to claim 1, wherein the tubular body of the compensator is shaped in the form of a thin-walled cylinder having a plurality of corrugations with preferential bending lines to allow the axial shortening or lengthening of the tubular wall, such that this wall can follow the axial movement of the plug relative to the valve seat, thus acting as a seal.

5. The device according to claim 4, wherein closure ends of the tubular cavity are provided at the opposite ends of the tubular body and are connected sealingly to the tubular wall, thus ensuring that the inner cavity formed in the tubular body is tightly sealed by said opposing ends and by the tubular wall.

6. The device according to claim 1, wherein said diaphragm is made from metal material.

7. The device according to claim 1, wherein said plug is made from rubber.
